(19) United States
(12) Patent Application Publication
(10) Pub. No.: US 2025/0016009 A1
(43) Pub. Date: Jan. 9, 2025

(54) REMOTE COLLECTOR-BASED UPDATING OF MONITORED ENDPOINTS

(71) Applicant: VMware LLC, Palo Alto, CA (US)

(72) Inventors: Rahul Singh, Bangalore (IN); Vineeth Totappanavar, Bangalore (IN); Venkata Padma Kaki, West Godavari (IN); Bhuvaneswari Addanki, Bangalore (IN); Atreyee Bhaduri, Bangalore (IN)

(21) Appl. No.: 18/243,115

(22) Filed: Sep. 7, 2023

(30) Foreign Application Priority Data
Jul. 7, 2023 (IN) 202341045734

(51) Int. Cl. H04L 9/32; H04L 41/082

(52) U.S. Cl. CPC H04L 9/3263; H04L 41/082

(57) ABSTRACT

The system includes a first endpoint executing a configuration agent and a second endpoint executing a remote collector. The remote collector may use a first service to receive metrics of the first endpoint based on a first client certificate. The remote collector includes a detection unit to detect whether the second endpoint has been added to or removed from a collector group that shares responsibility for monitoring functions to support high availability. The remote collector includes a certificate generation unit to generate a second client certificate for the first endpoint based on whether the second endpoint has been added to or removed from the collector group. Further, the remote collector includes a configuration master to update the first endpoint to replace the first client certificate with the second client certificate and cause the first endpoint to post metrics to a second service at the remote collector.

### RELATED APPLICATIONS

Benefit is claimed under 35 U.S.C. 119 (a)-(d) to Foreign Application Serial No. 202341045734 filed in India entitled “REMOTE COLLECTOR-BASED UPDATING OF MONITORED ENDPOINTS”, on Jul. 7, 2023, by VMware, Inc., which is herein incorporated in its entirety by reference for all purposes.

### TECHNICAL FIELD

The present disclosure relates to computing environments, and more particularly to methods, techniques, and systems for updating monitored endpoints of a computing environment using a remote collector.

### BACKGROUND

In application/operating system (OS) monitoring environments, a management node that runs a monitoring tool (i.e., a monitoring application) may communicate with multiple endpoints (e.g., virtual computing instances (VCIs)) to monitor the endpoints via a remote collector (e.g., a cloud proxy). For example, an endpoint may be implemented in a physical computing environment, a virtual computing environment, or a cloud computing environment. Further, the endpoints may execute different applications via virtual machines (VMs), physical host computing systems, containers, and the like. In such environments, the endpoints may send performance data/metrics (e.g., application metrics, operating system metrics, and the like) from underlying operating system and/or services to the remote collector. Further, the remote collector may provide the performance metrics to the monitoring tool for storage and performance analysis (e.g., to detect and diagnose issues).

### BRIEF DESCRIPTION OF THE DRAWINGS

FIG. 1A is a block diagram of an example system, depicting a remote collector to update an endpoint based on whether the remote collector has been added to or removed from a collector group;

FIG. 1B is a block diagram of the example system of FIG. 1A, depicting the updated endpoint when the remote collector is added to the collector group;

FIG. 2 is a block diagram of an example system, depicting a cloud proxy to update a virtual machine in response to detecting that the cloud proxy is added to a collector group;

FIG. 3A is a sequence diagram illustrating an example sequence of events performed by a remote collector to update an endpoint when remote collector is added to a collector group;

FIG. 3B is a sequence diagram illustrating an example sequence of events performed by a remote collector to update an endpoint when remote collector is removed from a collector group;

FIG. 4 is a flow diagram illustrating an example method performed by a remote collector for updating a first endpoint in response to detecting that the remote collector is removed from a collector group; and

FIG. 5 is a block diagram of an example second endpoint including non-transitory computer-readable storage medium storing instructions to execute a script for updating a first endpoint when a remote collector that monitors the endpoint is added to a collector group.

The drawings described herein are for illustrative purposes and are not intended to limit the scope of the present subject matter in any way.

### DETAILED DESCRIPTION

Examples described herein may provide an enhanced computer-based and/or network-based method, technique, and system to update monitored endpoints using remote collectors in a computing environment. The paragraphs to present an overview of the computing environment, existing methods to update the endpoints in the computing environment, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., a central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products. Thus, the computing environment may include multiple endpoints such as physical host computing systems, virtual machines, software defined data centers (SDDCs), containers, and/or the like.

Further, performance monitoring of the endpoints has become increasingly important because performance monitoring may aid in troubleshooting (e.g., to rectify abnormalities or shortcomings, if any) the endpoints, provide better health of data centers, analyse the cost, capacity, and/or the like. An example performance monitoring tool or application or platform may be VMware® vRealize Operations (vROps), VMware Wavefront™, Grafana, and the like. Such performance monitoring tools may be used to monitor a datacentre on a private, public, and/or hybrid cloud.

In some examples, the endpoints may include monitoring agents (e.g., Telegraf™, Collectd, Micrometer, and the like) to collect the performance metrics from the respective endpoints and provide, via a network, the collected performance metrics to a remote collector (e.g., a Cloud Proxy (CP)). For example, a monitoring agent such as Telegraf™ agent running in an endpoint may collect metrics from the endpoint and publish them to a metrics receiver. In this example, an Apache HTTPD server serves as the metrics receiver in the CP. The Apache HTTPD server running in the CP may listen on a specific location directive on port 443 to receive the metrics from the Telegraf™ agent.

Further, the remote collector may receive the performance metrics from the monitoring agents and transmit the performance metrics to a monitoring tool or a monitoring application for metric analysis. A remote collector may refer to a service/program that is installed in an additional cluster node (e.g., a virtual machine). The remote collector may allow the monitoring application (e.g., vROps Manager) to gather objects into the remote collector's inventory for monitoring purposes. The remote collector collects the data from the endpoints and then forward the data to an application monitoring server that executes the monitoring application. For example, remote collectors may be deployed at remote location sites while the monitoring tool may be deployed at a primary location. In an example, vROps is a multi-node application that can monitor geographically distributed datacentres. In such a distributed environment, remote collectors are installed at each geo location to monitor and control endpoints at respective datacentres. These remote collectors act as communication medium between master node (i.e., the monitoring application) and the datacentre. Furthermore, the monitoring application may receive the performance metrics, analyse the received performance metrics, and display the analysis in a form of dashboards, for instance. The displayed analysis may facilitate in visualizing the performance metrics and diagnose a root cause of issues, if any.

In such examples, the monitoring application (e.g., vROps) may use the remote collector (e.g., a cloud proxy) to support application and operating system monitoring. The cloud proxy may install the agents on the endpoints to monitor applications and an operating system running in the endpoints. For example, the agents installed on the endpoints may include a monitoring agent (e.g., Telegraf™), a supporting agent (e.g., UCP-minion), and a configuration agent (e.g., salt-minion). In an example software-as-a-service (SaaS) platform, the cloud proxy includes a data plane provided by an Apache HTTPD web server via hypertext transfer protocol secure (HTTPS) protocol and a control plane provided via Salt. In such an example SaaS platform, each endpoint may host the monitoring agent (e.g., Telegraf Agent) for posting application and operating system metrics to the remote collector, the supporting agent for posting service discovery and health metrics to the remote collector, and the configuration agent for receiving control actions/commands from the remote collector. Further, the Telegraf agent and the UCP minion of the data plane may publish metrics to the Apache HTTPD web server running in the cloud proxy. Furthermore, the Salt minion of the control plane may communicate with the Salt master running in the remote collector. Further, control commands such as updating the agents, starting/stopping the agents, and the like may be performed via the Salt minions upon the request of the Salt master.

The remote collector may use Apache httpd service for data plane. The Apache httpd service may use certificate-based authentication for metrics being posted at the cloud proxy. In this example, as part of agent installation at the endpoint, client certificates or client authentication certificates (e.g., OpenSSL certificate) are placed at the endpoint. Client authentication for metrics being posted from the endpoints to the remote collector is being done by using remote collector's Certificate Authority (CA) certificate and the client certificates placed at the endpoints during agent install operation.

Further, the remote collector (e.g., the cloud proxy) may support high availability for application monitoring by deploying at least two remote collectors and linking them with a collector group. The collector group may be a virtual entity that allows the remote collectors to be grouped together. For example, cloud proxies may provide high availability within the cloud environment, in which two or more cloud proxies are grouped to form the collector group. The cloud proxy collector group may ensure that there is no single point of failure in the cloud environment. If one of the cloud proxies experiences a network interruption or becomes unavailable, the other cloud proxy from the collector group takes charge and ensures that there is no downtime. In the example of cloud proxy collector group, a “KeepaliveD” service may be utilized at the remote collector to support high availability within the collector group. The “KeepaliveD” service is a framework for both load balancing and high availability that implements a virtual router redundancy protocol (VRRP). The VRRP creates a virtual IP (or VIP, or floating IP) that acts as a gateway to route traffic from the monitored endpoints.

For example, when the cloud proxy belongs to the collector group, the KeepaliveD service acts as a receiver of the metrics from the endpoints being monitored by the cloud proxy. When the cloud proxy is not a member of the collector group, the Apache httpd service may be utilized to receive the metrics from the cloud proxy. In addition, the cloud proxies in the collector group may share the same server (e.g., the cloud proxy) CA certificate.

In the existing architecture, the remote collector can move-in or move-out of the collector group. In such a scenario, depending on whether the remote collector is a member of the collector group or not, the agents (e.g., the monitoring agent, the supporting agent, and the like) installed in the endpoints may have to be modified to post metrics to either the Apache httpd service or the KeepaliveD service.

Further, when the remote collector is added to the collector group, remote collector's CA certificate may have to be replaced by a new CA certificate which may be shared among the remote collectors across the collector group. Due to change in server CA certificate at the remote collector, the client certificate of the endpoints monitored by the remote collector may have to be replaced by a newly generated client certificate using new CA certificate of the remote collector. Similarly, when the remote collector is moved-out of the collector group, the remote collector server certificate may have to be replaced with the self-signed CA certificate, which in case requires the endpoint client certificate to be regenerated and replaced at the endpoint.

In some examples, the remote collector may monitor significantly large number of endpoints (e.g., around 4K endpoints). Further, there is a need to ensure that the endpoints send the critical metrics to the remote collector, i.e., the data plane may have to work properly. Furthermore, updating the agents at the endpoints in case of the remote collector being added or removed from the collector group can be performed by following ways.
End user may have to manually update the agents, replace client certificates, and restart required services on the endpoint. However, manually updating the endpoint may be risk prone, cumbersome, and affect user experience.
User could reinstall and reconfigure the endpoints. However, this method may cause historical data loss as well as the customers may have to be wary of re-entering the passwords in order to reinstall/reconfigure the endpoint agents.

Examples described herein may provide a remote collector including a script to update endpoints that are being monitored by the remote collector when the remote collector is added to/removed from a collector group. An example system may include a first endpoint executing a configuration agent and a second endpoint executing a remote collector. The remote collector may use a first service to receive metrics of the first endpoint based on a first client certificate. Further, the remote collector may include a detection unit to detect whether the second endpoint has been added to or removed from a collector group that shares responsibility for monitoring functions to support high availability. Further, the remote collector may include a certificate generation unit and a configuration master. Based on whether the second endpoint has been added to or removed from the collector group, the certificate generation unit may generate a second client certificate for the first endpoint. Furthermore, the configuration master may update, via the configuration agent, the first endpoint to replace the first client certificate with the second client certificate and cause the first endpoint to post metrics to a second service at the remote collector.

In an example, when the second endpoint has been added to the collector group, the certificate generation unit may generate the second client certificate for the first endpoint using a certificate Authority (CA) certificate of the collector group. Further, the configuration master may replace the first client certificate in the first endpoint with the second client certificate. In addition, the configuration master may update a data plane of the first endpoint to replace an Internet Protocol (IP) address used by the first endpoint to post the metrics to the first service with a virtual IP address of the second service and cause the first endpoint to post the metrics to the virtual IP address of the second service.

The remote collector described herein may use an existing control channel (i.e., the configuration master and the configuration agent) to trigger the changes on the endpoints so that the agents can post the metrics to the required service at the remote collector based on either the remote collector is added to or removed from the collector group. Thus, examples described herein may ensure that the endpoints are updated without the need to reinstall/reconfigure the endpoints or to manually perform updating of the endpoint based on whether the remote collector is part of the collector group or not.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

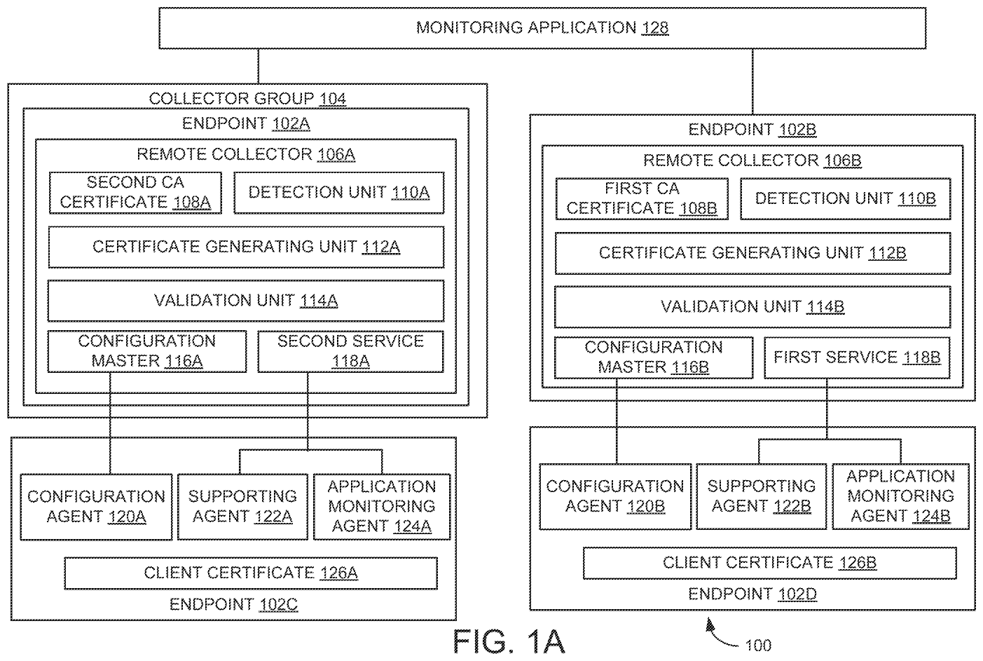

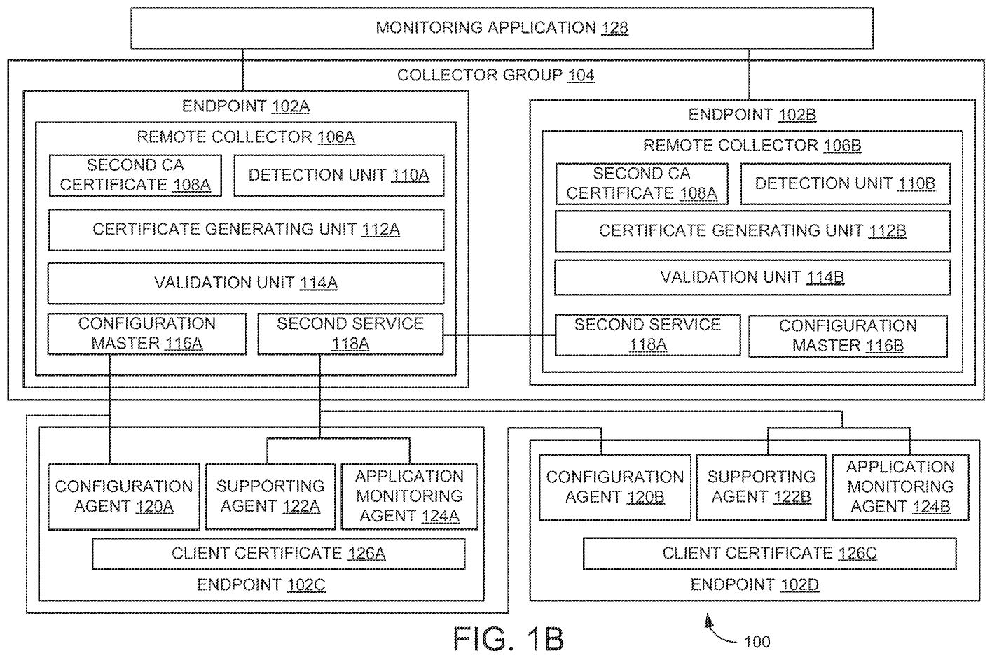

Referring now to the figures, FIG. 1A is a block diagram of an example system 100, depicting a remote collector 106B to update an endpoint (e.g., a first endpoint 102D) based on whether the remote collector has been added to or removed from a collector group. Example system 100 may include a computing environment such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications or services or programs. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

Example system 100 may be a data center that includes multiple endpoints 102A to 102D. In an example, an endpoint may include, but not limited to, a virtual machine, a physical host computing system, a container, a software defined data center (SDDC), or any other computing instance that executes different applications. The endpoint can be deployed either on an on-premises platform or an off-premises platform (e.g., a cloud managed SDDC). An SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. An example of a host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of the host's operating system without the need for the hypervisor or separate operating system.

Further, each of endpoints 102C and 102D may include an application monitoring agent (e.g., 124A and 124B) to monitor applications, services, and/or programs running in respective endpoints 102C and 102D. In an example, application monitoring agents 124A and 124B may be installed in respective endpoints 102C and 102D to fetch the metrics from various components of endpoints 102C and 102D. For example, application monitoring agents 124A and 124B may real-time monitor respective endpoints 102C and 102D to collect the metrics (e.g., telemetry data) associated with an application or an operating system running in endpoints 102C and 102D. An example application monitoring agent may be Telegraf agent, Collectd agent, or the like. Example metrics may include performance metric values associated with at least one of central processing unit (CPU), memory, storage, graphics, network traffic, applications, or the like.

Furthermore, each of endpoints 102C and 102D may include respective supporting agents 122A and 122B (e.g., UCP-minions) and configuration agents 120A and 120B (e.g., salt-minions). For example, supporting agents 122A and 122B may obtain service discovery metrics including a list of services running in respective endpoints 102C and 102D, health metrics of respective application monitoring agents 124A and 124B, or a combination thereof. Further, configuration agents 120A and 120B may receive control commands from respective configuration masters 116A and 116B of remote collectors 106A and 106B, respectively. For example, configuration master 116B may run as part of a docker container on endpoint 102B that executes remote collector 106B. Thus, remote collectors 106A and 106B may perform the control commands such as updating the agents, starting/stopping the agents, and the like on respective endpoints 102C and 102D via configuration agents 120A and 120B.

As shown in FIG. 1A, each of endpoints 102A and 102B may include corresponding remote collectors 106A and 106B. In the example shown in FIG. 1A, system 100 may include a collector group 104, i.e., a virtual entity that allows the remote collectors to be grouped together to provide high availability. Consider that remote collector 106A is part of collector group 104 and remote collector 106B is not part of collector group 104. In this example, application monitoring agent 124B and supporting agent 122B of endpoint 102D may publish metrics to a first service 118B (e.g., an Apache httpd service) at remote collector 106B. Thus, endpoint 102B executing remote collector 106B may use first service 118B to receive metrics of endpoint 102D based on a first client certificate 126B.

In the case of remote collector 106A, application monitoring agent 124A and supporting agent 122A of endpoint 102C may publish metrics to a second service 118A (e.g., a KeepaliveD service) at remote collector 106A associated with collector group 104. Within collector group 104, monitoring application 128 may support high availability (HA) for application monitoring. Collector group 104 may be a virtual entity that allows remote collectors to be grouped together. For example, second service 118A (e.g., the KeepaliveD service) may be utilized at remote collector 106A to support high availability inside collector group 104. Thus, endpoint 102A executing remote collector 106A may use second service 118A to receive metrics of endpoint 102C based on a second client certificate 126A. The KeepaliveD may be a framework to support both load balancing and high availability that implements a virtual router redundancy protocol (VRRP). The VRRP creates a virtual IP (or VIP, or floating IP) that acts as a gateway to route traffic. Further, a configuration agent 120A of endpoint 102C may receive control commands from a configuration master 116A of remote collector 106A.

Thus, remote collectors 106A and 106B may communicate with respective endpoints 102C and 102D to receive metrics of endpoints 102C and 102D using corresponding services (e.g., second service 118A and first service 118B). Further, remote collectors 106A and 106B may send the received metrics to a monitoring application 128. Furthermore, monitoring application 128 may run in an application monitoring server to analyse the received metrics.

In some examples, endpoints 102A and 102B may be communicatively connected to endpoints 102C and 102D, and monitoring application 128 via a network. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

In an example, each of remote collectors 106A and 106B may include respective detection units 110A and 110B, respective certificate generating units 112A and 112B, respective configuration masters 116A and 116B, and respective validation units 114A and 114B. During operation, detection unit 110B may detect whether endpoint 102B has been added to or removed from collector group 104 that shares responsibility for monitoring functions to support high availability. Further, certificate generation unit 112B may generate a second client certificate for endpoint 102D based on whether endpoint 102B has been added to or removed from collector group 104.

When endpoint 102B is added to collector group 104, certificate generation unit 112B may generate the second client certificate for endpoint 102D using a Certificate Authority (CA) certificate of collector group 104. When endpoint 102B is removed from collector group 104, certificate generation unit 112B may generate the second client certificate for endpoint 102D using a self-signed Certificate Authority (CA) certificate 108B of remote collector 106B.

Furthermore, configuration master 116B may update, via configuration agent 120B, endpoint 102D to replace first client certificate 126B with the second client certificate and cause endpoint 102D to post metrics to a second service (e.g., second service 118A) at collector group 104, which is described in FIG. 1B. In an example, configuration agent 120B may receive a control command from configuration master 116B and execute the command to update endpoint 102D.

In an example, configuration master 116B may update, via configuration agent 120B, an application monitoring agent 124B running in endpoint 102D to cause application monitoring agent 124B to post first metrics to the second service of collector group 104. For example, the first metrics may include performance metrics associated with an operating system, an application, or both running in first endpoint 102D. In another example, configuration master 116B may update, via configuration agent 120B, supporting agent 122B running in endpoint 102D to cause supporting agent 122B to post second metrics to the second service at remote collector 106A. For example, the second metrics may include service discovery metrics including a list of services running in endpoint 102D, health metrics of application monitoring agent 124B, or both.

Further, validation unit 114B may establish a communication from endpoint 102D to remote collector 106B based on the second client certificate. Upon establishing the communication, validation unit 114B may enable the second service to receive the metrics from endpoint 102D.

In an example, configuration master 116B may apply, via configuration agent 120B running in endpoint 102D, a control command to endpoint 102D to stop an agent (e.g., application monitoring agent 124B and supporting agent 122B) running in endpoint 102D, download the second client certificate from endpoint 102B to endpoint 102D, replace first client certificate 126B with the downloaded second client certificate, update endpoint 102D to post metrics to the second service at collector group 104, and start the agent on endpoint 102D to enable the agent to send the metrics to the second service using the second client certificate.

Consider that endpoint 102B is added to collector group 104. In this example, configuration master 116B may update a data plane of endpoint 102D to replace an Internet Protocol (IP) address used by endpoint 102D to post the metrics to first service 118B (e.g., Apache HTTPD service) with a virtual IP address of second service 118A and cause endpoint 102D to post the metrics to the virtual IP address of second service 118A. For example, second service 118A may include a KeepaliveD service, a dedicated active/passive load balancer across two remote collectors 106A and 106B, which forward traffic to a pool of two remote collectors.

Consider that endpoint 102B is removed from collector group 104. In this example, configuration master 116B may update a data plane of endpoint 102D to replace a virtual IP address used by endpoint 102D to post the metrics to the first service (e.g., KeepaliveD service) with an IP address of the second service (e.g., Apache HTTPD service) and cause endpoint 102D to post the metrics to the IP address of first service 118B.

FIG. 1B is a block diagram of example system 100 of FIG. 1A, depicting updated endpoint 102D when remote collector 106B is added to collector group 104. For example, similarly named elements of FIG. 1B may be similar in structure and/or function to elements described with respect to FIG. 1A. For example, when remote collector 106B is added to collector group 104, one of remote collectors (e.g., remote collector 106A) in collector group 104 may function as a master remote collector and another remote collector (e.g., remote collector 106B) may function as a standby remote collector.

In the example shown in FIG. 1B, the first client certificate (e.g., client certificate 126B generated using self-signed CA certificate 108A of remote collector 106B) is replaced with the second client certificate (e.g., client certificate 126C generated using CA certificate 108A of the collector group 104). Further, a data plane of the first endpoint 102D is updated to replace the IP address used by first endpoint 102D to post the metrics to first service 118B (e.g., the Apache HTTPD service) with a virtual IP address of second service 118A (e.g., the KeepaliveD service) such that first endpoint 102D is to post the metrics to the virtual IP address of second service 118A.

Thus, when remote collector 106B belongs to collector group 104, second service 118A, e.g., the KeepaliveD service may act as a receiver of metrics from endpoint 102D being monitored by remote collector 106B. When remote collector 106B is not a member of collector group 104, first service 118B, e.g., the Apache HTTPD service may be utilized to receive metrics from endpoint 102D. Further, the remote collectors in collector group 104 share the same server (e.g., cloud proxy) CA certificate. Thereby, examples described herein may ensure that application monitoring agent 124B in endpoint 102D is updated when remote collector 106B is coming in or going out of collector group 104 without the need to reinstall/reconfigure endpoint 102D or to manually perform this activity on endpoint 102D.

In some examples, the functionalities described in FIGS. 1A and 1B, in relation to instructions to implement functions of detection units 110A and 110B, certificate generating units 112A and 112B, configuration masters 116A and 116B, validation units 114A and 114B, configuration agents 120A and 120B, supporting agents 122A and 122B, application monitoring agents 124A and 124B, and any additional instructions described herein in relation to the storage medium, may be implemented as engines or modules including any combination of hardware and programming to implement the functionalities of the modules or engines described herein. The functions of detection units 110A and 110B, certificate generating units 112A and 112B, configuration masters 116A and 116B, validation units 114A, configuration agents 120A and 120B, supporting agents 122A and 122B, and application monitoring agents 124A and 124B may also be implemented by a processor. In examples described herein, the processor may include, for example, one processor or multiple processors included in a single device or distributed across multiple devices.

Further, the cloud computing environment illustrated in FIGS. 1A and 1B are shown purely for the purposes of illustration and are not intended to be in any way inclusive or limiting to the embodiments that are described herein. For example, a typical cloud computing environment would include many more remote servers (e.g., endpoints), which may be distributed over multiple data centers, which might include many other types of devices, such as switches, power supplies, cooling systems, environmental controls, and the like, which are not illustrated herein. It will be apparent to one of ordinary skills in the art that the example shown in FIGS. 1A and 1B, as well as all other figures in this disclosure have been simplified for ease of understanding and are not intended to be exhaustive or limiting to the scope of the idea.

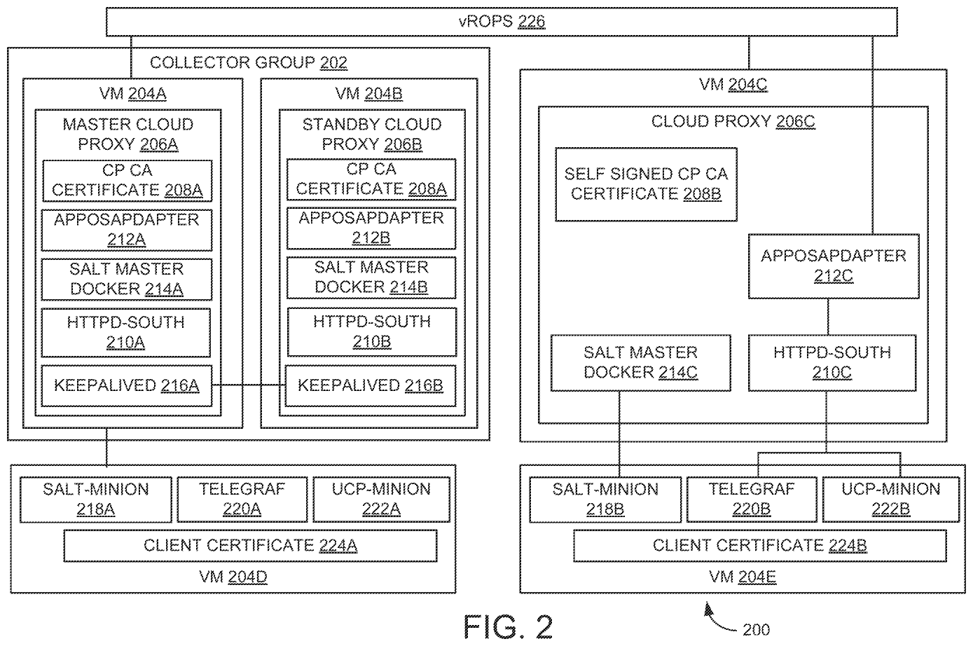

FIG. 2 is a block diagram of an example system 200, depicting a cloud proxy 206C to update a virtual machine upon detecting that cloud proxy 206C is added to a collector group. Example system 200 may include a virtualized cloud computing environment. Example system 200 may be a data center that includes multiple virtual machines 204A to 204E (e.g., endpoints). For example, in a collector group 202, virtual machine 204A may include a master cloud proxy 206A (e.g., a master remote collector) and virtual machine 204B may include a standby cloud proxy 206B (e.g., a standby remote collector) to serve high availability. Further, each of virtual machines 204D and 204E may include respective salt-minions (e.g., 218A and 218B), respective Telegrafs (e.g., 220A and 220B), and respective UCP-minions (e.g., 222A and 222B). Also, each of virtual machines 204D and 204E may include corresponding client certificates (e.g., 224A and 224B) to communicate with corresponding cloud proxies (e.g., 206A and 206C).

For example, a cloud proxy may run on Photon operating system version 3.0, a processor (e.g., 2CPU), and a storage (e.g., 80 GB storage). Further, the cloud proxy may include a data plane and a control plane. For example, the data plane may be provided by an Apache HTTPD service (e.g., 210A, 210B, and 210C) or a KeepaliveD service (e.g., 216A and 216B) and the control plane may be provided via a Salt master (e.g., 214A, 214B, and 214C) (e.g., a configuration master).

Consider cloud proxy 206C, which is not a part of collector group 202. In this example, Apache httpd service 210C may be used as metric receiver at cloud proxy 206C to receive metrics from monitored virtual machine 204E based on a client certificate 224B. For example, client certificate 224B may be generated by self-signed cloud proxy CA certificate 208B of cloud proxy 206C. Further, cloud proxy 206C may communicate with virtual machine 204E using a salt master 214C (i.e., a configuration master) and a salt-minion 218B (i.e., a configuration agent). Furthermore, cloud proxy 206C may transmit the received metrics from endpoint 204E to vROps 226 (i.e., a monitoring application) via an adapter (e.g., Apposadapter 212C) for metrics analysis.

Consider master cloud proxy 206A, which is a part of collector group 202. In this example, KeepaliveD 216A may be used as metric receiver at cloud proxy 206A to receive metrics from monitored virtual machine 204D based on a client certificate 224A. For example, client certificate 224A may be generated by cloud proxy CA certificate 208A. Further, cloud proxy 206A may communicate with virtual machine 204D using a salt master 214A and a salt-minion 218A. Furthermore, cloud proxy 206A may transmit the received metrics from endpoint 204D to vROps 226 via an adapter (e.g., Apposadapter 212A) for metrics analysis. In this example, standby cloud proxy 206B may act as a master cloud proxy when cloud proxy 206A is down. For example, standby cloud proxy 206B may include Apposadapter 212B, salt master 214B, Apache HTTPD service 210B, and KeepliveD service 216B.

During operation, each of cloud proxies 206A to 206C may detect whether cloud proxy is added to or removed from collector group 202. For example, when cloud proxy 206C is added to collector group 202, Telegraf 220B, UCP-minion 222B, and salt-minion 218B are dynamically updated along with new client certificate from cloud proxy 206C by executing a script. Further, KeepaliveD service 216A may expose virtual IP for virtual machine 204E to publish metrics data from virtual machine 204E. Similarly, when cloud proxy 206A is removed from collector group 202, virtual machine 204D may be updated with new client certificate from cloud proxy 206A by executing a script. In this example, virtual IP may be replaced to cloud proxy IP to post metrics to Apache httpd service at cloud proxy 206A.

In the examples described herein, a cloud proxy may use salt for control plane activities on a virtual machine and as a configuration manager. Further, salt may use a server-agent communication model, where the server component is called the salt master and the agent is called the salt minion. The salt master may run as part of a docker container on the virtual machine of the cloud proxy. Furthermore, the salt state may be applied from the salt master to the salt minion to apply control commands on the virtual machines. The virtual machine's configuration manager may include properties used by the supporting agent (e.g., UCP-minion) to post metrics to the cloud proxy. Further, salt master at the cloud proxy may host files (e.g., certificates) which can be downloaded by salt minion at the virtual machine when the control command is executed using the salt state. For example, the salt file server may be a ZeroMQ stateless server. It is built into the salt master. The ZeroMQ is an asynchronous messaging library, aimed at use in distributed or concurrent applications. Further, the ZeroMQ sockets may provide a layer of abstraction on top of the traditional socket application programming interface (API), which allows it to hide much of the everyday boilerplate complexity. Furthermore, the salt file server may be used for distributing files from master to minions.

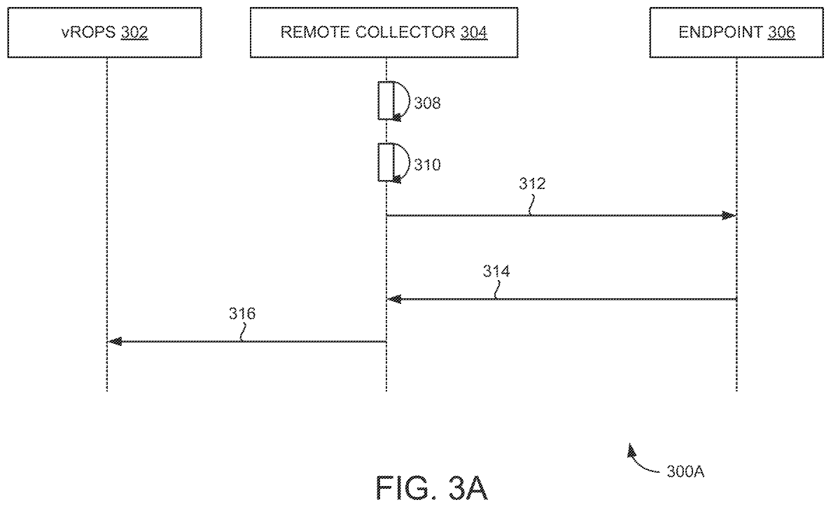

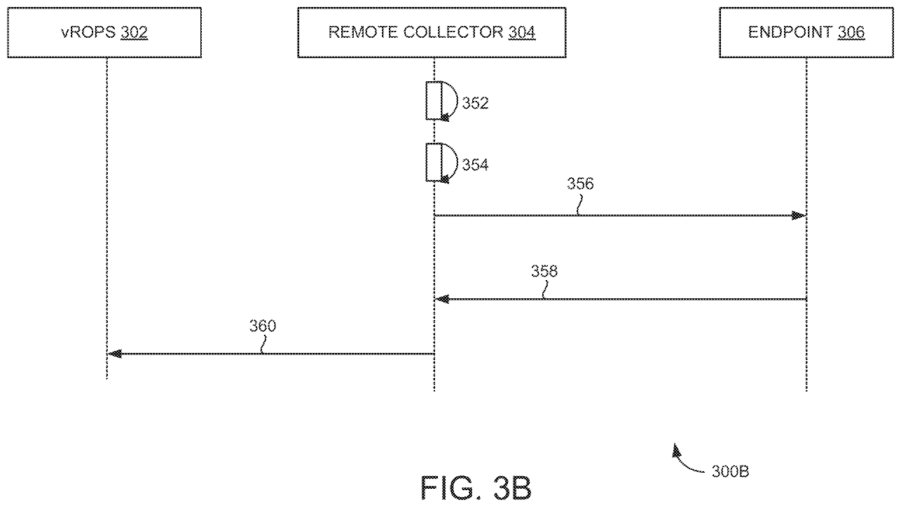

FIG. 3A is a sequence diagram 300A illustrating an example sequence of events performed by a remote collector 304 to update an endpoint 306 when remote collector 304 is added to a collector group (e.g., collector group 104 of FIG. 1A). Sequence diagram 300A may represent the interactions and the operations involved in updating endpoint 306. FIG. 3A illustrates process objects including vROps (e.g., a monitoring application) 302, remote collector 304, and endpoint 306 along with their respective vertical lines originating from them. The vertical lines of vROps 302, remote collector 304, and endpoint 306 may represent the processes that may exist simultaneously. The horizontal arrows (e.g., 312, 314, and 316) may represent the data flow steps between the vertical lines originating from their respective process objects (for e.g., vROps 302, remote collector 304, and endpoint 306). Further, activation boxes (e.g., 308 and 310) between the horizontal arrows may represent the process that is being performed in the respective process object.

At 308, remote collector 304 may execute a script when remote collector 304 is added to the collector group. The script may be executed to generate a new client certificate for endpoint 306 monitored by remote collector 304 using a CA certificate of the collector group.

At 310, remote collector 304 may host generated new certificate to a salt master's file server. At 312, remote collector 304 may execute a salt state to update the client certificate on endpoint 306 and replace remote collector fully qualified domain name (e.g., cloud proxy FQDN) with a virtual internet protocol (IP) (e.g., KeepaliveD virtual IP) and start agent services on endpoint 306. For example, remote collector 304 may apply the salt state at endpoint 306 to perform following operations:
stop a supporting agent (e.g., UCP-minion) and a monitoring agent (e.g., Telegraf™) on endpoint 306,
download the hosted OpenSSL certificate for endpoint 306 from remote collector 304 to endpoint 306,
replace the existing OpenSSL certificate with the newly downloaded one at endpoint 306,
update the configuration manager properties by replacing remote collector FQDN with a virtual IP as data plane for remote collector 304,
update the monitoring agent's configuration and the supporting agent's configuration to post the metrics to the remote collector's virtual IP, and
start the supporting agent and the monitoring agent on endpoint 306.

At 314, an application monitoring agent (e.g., Telegraf) and supporting agent (e.g., UCP-minion) in endpoint 306 may send performance metrics of endpoint 306 to the KeepaliveD service at remote collector 304 using the new client certificate. At 316, remote collector 304 may transmit the performance metrics of endpoint 306 to vROps 302 for metrics analysis (e.g., to detect and diagnose issues).

FIG. 3B is a sequence diagram 300B illustrating an example sequence of events performed by a remote collector 304 to update an endpoint 306 when remote collector 304 is removed from a collector group (e.g., collector group 104 of FIG. 1A). Sequence diagram 300B may represent the interactions and the operations involved in updating endpoint 306. For example, similarly named elements of FIG. 3B may be similar in structure and/or function to elements described with respect to FIG. 3A. FIG. 3B illustrates process objects including vROps (e.g., a monitoring application) 302, remote collector 304, and endpoint 306 along with their respective vertical lines originating from them. The vertical lines of vROps 302, remote collector 304, and endpoint 306 may represent the processes that may exist simultaneously. The horizontal arrows (e.g., 356, 358, and 360) may represent the data flow steps between the vertical lines originating from their respective process objects (for e.g., vROps 302, remote collector 304, and endpoint 306). Further, activation boxes (e.g., 352 and 354) between the horizontal arrows may represent the process that is being performed in the respective process object.

At 352, remote collector 304 may execute a script when remote collector 304 is removed from the collector group. The script may be executed to generate a new client certificate for endpoint 306 monitored by remote collector 304 using self-signed server CA certificate of remote collector 304.

At 354, remote collector 304 may host generated new certificate on a salt master's file server. At 356, remote collector 304 may execute a salt state to update the client certificate on endpoint 306 and replace the virtual internet protocol (IP) (e.g., KeepaliveD virtual IP) with remote collector FQDN. For example, remote collector 304 may apply the salt state at endpoint 306 to perform the following operations:
such as to stop a supporting agent (e.g., UCP-minion) and a monitoring agent (e.g., Telegraf) on endpoint 306,
download the hosted OpenSSL certificate for endpoint 306 from remote collector 304 to endpoint 306,
replace the existing OpenSSL certificate with the newly downloaded one at endpoint 306,
update properties at the configuration manager, replace Virtual IP with remote collector FQDN as the data plane for remote collector 304,
update the monitoring agent configuration to post metrics to the remote collector FQDN on remote collector 304, and
start the supporting agent and the monitoring agent on endpoint 306.

At 358, the application monitoring agent and the supporting agent in endpoint 306 may send performance metrics of endpoint 306 to Apache HTTPD server of remote collector 304 using the new client certificate. At 360, remote collector 304 may transmit the performance metrics of endpoint 306 to vROps 302 for metrics analysis (e.g., to detect and diagnose issues).

Examples described herein may dynamically update the agents and client certificate in the endpoints using a single script based on whether the remote collector is part of the collector group or not (e.g., whenever a chance occur in the data plane). Thus, the endpoints being monitored by the remote collector may automatically be brought to same state at the remote collector after salt state is applied. i.e., no reinstall of agents are required. Further, without any explicit operation performed by the user at each endpoint for agents update and certificate replacement, the agents may start sending metrics to the remote collector desired service after script execution.

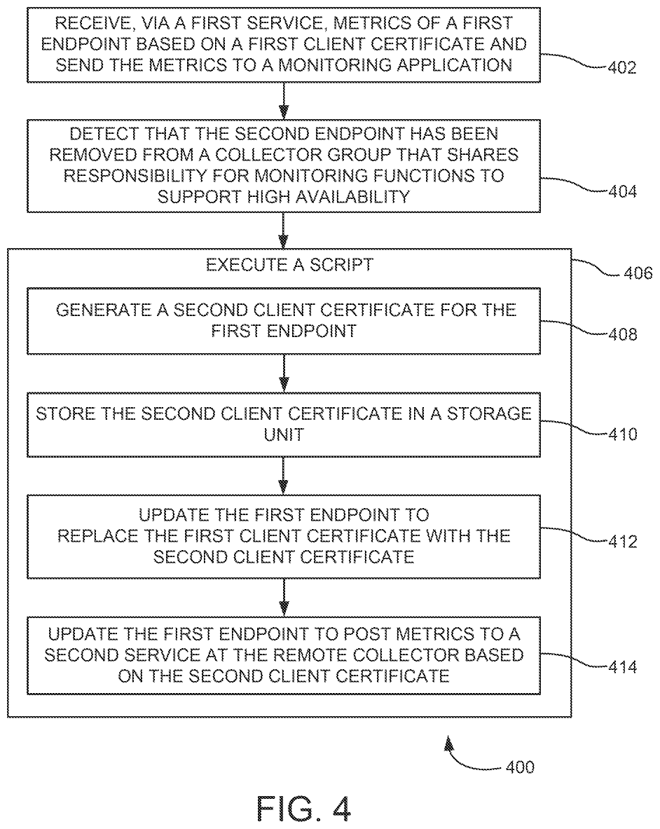

FIG. 4 is a flow diagram illustrating an example method 400 performed by a remote collector for updating a first endpoint in response to detecting that the remote collector is removed from a collector group. For example, method 400 may be performed by a remote collector executing on a second endpoint. Example method 400 depicted in FIG. 4 represents generalized illustrations, and other processes may be added, or existing processes may be removed, modified, or rearranged without departing from the scope and spirit of the present application. In addition, method 400 may represent instructions stored on a computer-readable storage medium that, when executed, may cause a processor to respond, to perform actions, to change states, and/or to make decisions. Alternatively, method 400 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 402, metrics of a first endpoint may be received based on a first client certificate via a first service and send the metrics to a monitoring application. At 404, a check may be made to detect that the second endpoint has been removed from a collector group that shares responsibility for monitoring functions to support high availability.

In response to detecting that the second endpoint has been removed from the collector group, at 406, a script may be executed to perform the processes in blocks 408, 410, 412 and 414. At 408, a second client certificate may be generated for the first endpoint. In an example, generating the second client certificate for the first endpoint may include generating the second client certificate for the first endpoint using a self-signed Certificate Authority (CA) certificate of the remote collector. At 410, the second client certificate may be stored in a storage unit.

At 412, the first endpoint may be updated, via a configuration agent of the first endpoint, to replace the first client certificate with the second client certificate. In an example, updating the first endpoint may include causing a configuration master of the second endpoint to update the first endpoint via the configuration agent running in the first endpoint. The configuration agent may receive a control command from the configuration master and execute the control command to update the first endpoint.

In another example, updating the first endpoint may include causing a configuration master of the second endpoint to apply, via the configuration agent running in the first endpoint, a control command to the first endpoint. The control command may stop at least one agent running in the first endpoint. At least one agent may use the first client certificate to send metrics of the endpoint to the first service. Further, the control command may download the stored second client certificate from the storage unit of the remote collector to the first endpoint, replace the first client certificate with the downloaded second client certificate. replace a virtual Internet Protocol (IP) address used by the endpoint to post the metrics to the first service with a fully qualified domain name (FQDN) of the second service and start the at least one agent such that the at least one agent is to post the metrics to the FQDN of the second service based on the second client certificate. At 412, the first endpoint may be updated, via the configuration agent of the first endpoint, to post metrics to a second service at the remote collector based on the second client certificate.

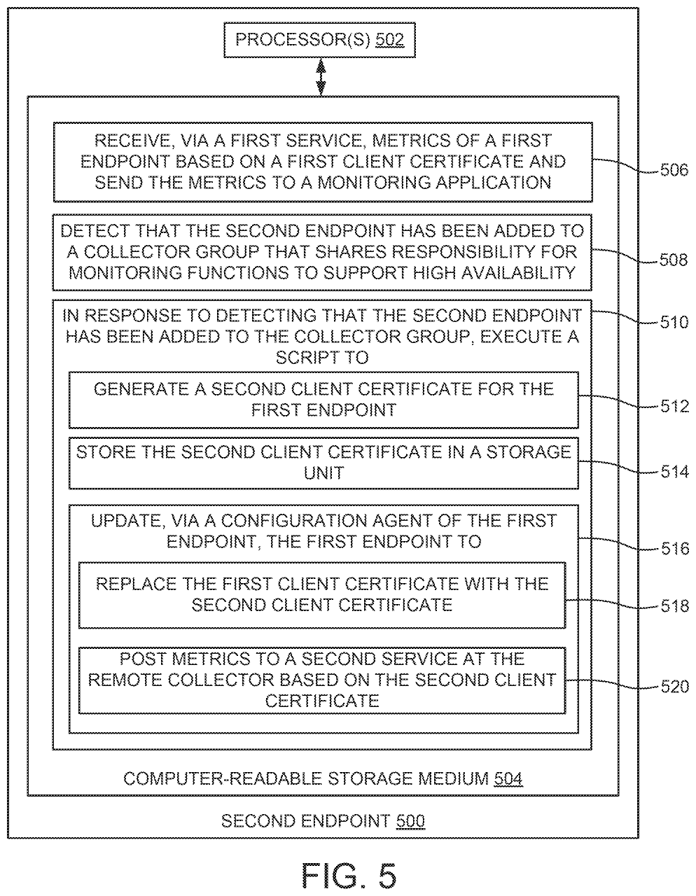

FIG. 5 is a block diagram of an example second endpoint 500 including non-transitory computer-readable storage medium 504 storing instructions to execute a script for updating a first endpoint when a remote collector that monitors the endpoint is added to a collector group. Second endpoint 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to second endpoint 500.

Computer-readable storage medium 504 may store instructions 506, 508, 510, 512, 514, 516, 518, and 520. Instructions 506 may be executed by processor 502 to receive, via a first service, metrics of the first endpoint based on a first client certificate and send the metrics to a monitoring application.

Instructions 508 may be executed by processor 502 to detect that the second endpoint has been added to a collector group that shares responsibility for monitoring functions to support high availability. In response to detecting that the second endpoint has been added to the collector group, instructions 510 may be executed by processor 502 to execute a script to execute instructions 512, 514, 516, 518, and 520. Instructions 512 may be executed by processor 502 to generate a second client certificate for the first endpoint. In an example, instructions 512 to generate the second client certificate for the first endpoint may include instructions to generate the second client certificate for the first endpoint using a Certificate Authority (CA) certificate of the collector group.

Instructions 514 may be executed by processor 502 to store the second client certificate in a storage unit. Further, instructions 516 may be executed by processor 502 to update the first endpoint via a configuration agent of the first endpoint. Instructions 518 may be executed by processor 502 to update the first endpoint to replace the first client certificate with the second client certificate. In an example, instructions 516 to update the first endpoint may include instructions to cause a configuration master of the second endpoint to update the first endpoint via the configuration agent running in the first endpoint. The configuration agent may receive a control command from the configuration master and execute the control command to update the first endpoint.

For example, instructions 516 to update the first endpoint may include instructions to cause the configuration master of the second endpoint to apply, via the configuration agent running in the first endpoint, a control command. The control command to the first endpoint may stop an application monitoring agent and a service discovery agent running in the first endpoint. Further, the control command may download the stored second client certificate from the storage unit of the remote collector to the first endpoint. Furthermore, the control command may replace the first client certificate with the downloaded second client certificate. Further, the control command may replace a fully qualified domain name (FQDN) used by the first endpoint to post the metrics to the first service with a virtual Internet Protocol (IP) address of the second service. Furthermore, the control command may start the application monitoring agent and the service discovery agent on the first endpoint to enable the application monitoring agent and the service discovery agent to post the metrics to the virtual IP address based on the second client certificate. Further, instructions 520 may be executed by processor 502 to update the first endpoint to post metrics to a second service at the remote collector based on the second client certificate.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not be meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a first endpoint executing a configuration agent; and
a second endpoint executing a remote collector, wherein the remote collector is to use a first service to receive metrics of the first endpoint based on a first client certificate, the remote collector comprising:
a detection unit to detect whether the second endpoint has been added to or removed from a collector group that shares responsibility for monitoring functions to support high availability;
a certificate generation unit to generate a second client certificate for the first endpoint based on whether the second endpoint has been added to or removed from the collector group; and
a configuration master to update, via the configuration agent, the first endpoint to:
replace the first client certificate with the second client certificate; and
cause the first endpoint to post metrics to a second service at the remote collector.

2. The system of claim 1, wherein the remote collector further comprising:
a validation unit to:
establish a communication from the first endpoint to the remote collector based on the second client certificate; and
upon establishing the communication, enable the second service at the remote collector to receive the metrics from the first endpoint.

3. The system of claim 1, wherein the configuration agent is to receive a control command from the configuration master and execute the command to update the first endpoint.

4. The system of claim 1, wherein the certificate generation unit is to:
when the second endpoint has been added to the collector group, generate the second client certificate for the first endpoint using a Certificate Authority (CA) certificate of the collector group.

5. The system of claim 1, wherein the certificate generation unit is to:
when the second endpoint has been removed from the collector group, generate the second client certificate for the first endpoint using a self-signed Certificate Authority (CA) certificate of the remote collector.

6. The system of claim 1, wherein the configuration master is to:
when the second endpoint has been added to the collector group:
update a data plane of the first endpoint to replace an Internet Protocol (IP) address used by the first endpoint to post the metrics to the first service with a virtual IP address of the second service; and
cause the first endpoint to post the metrics to the virtual IP address of the second service.

7. The system of claim 1, wherein the configuration master is to:
when the second endpoint has been removed from the collector group:
update a data plane of the first endpoint to replace a virtual Internet Protocol (IP) address used by the first endpoint to post the metrics to the first service with an IP address of the second service; and
cause the first endpoint to post the metrics to the IP address of the second service.

8. The system of claim 1, wherein the configuration master is to update, via the configuration agent, an application monitoring agent running in the first endpoint to:
cause the application monitoring agent to post first metrics to the second service at the remote collector, wherein the first metrics comprise performance metrics associated with an operating system, an application, or both running in the first endpoint.

9. The system of claim 1, wherein the configuration master is to update, via the configuration agent, a supporting agent running in the first endpoint to:
cause the supporting agent to post second metrics to the second service at the remote collector, wherein the second metrics comprise service discovery metrics including a list of services running in the first endpoint, health metrics of the monitoring agent, or both.

10. The system of claim 1, wherein the configuration master is to apply, via the configuration agent running in the first endpoint, a control command to the first endpoint to:
stop an agent running in the first endpoint;
download the second client certificate from the second endpoint to the first endpoint;
replace the first client certificate with the downloaded second client certificate;
update the first endpoint to post metrics to the second service at the remote collector; and
start the agent on the first endpoint to enable the agent to send the metrics to the second service using the second client certificate.

11. The system of claim 1, wherein the configuration master is to run as part of a docker container on the second endpoint that executes the remote collector.

12. The system of claim 1, wherein each of the first endpoint and the second endpoint comprises a virtual machine, a container, or a physical computing system.

13. A non-transitory computer-readable storage medium having instructions executable by a processor of a second endpoint to:
receive, via a first service, metrics of a first endpoint based on a first client certificate and send the metrics to a monitoring application;
detect that the second endpoint has been added to a collector group that shares responsibility for monitoring functions to support high availability; and
in response to detecting that the second endpoint has been added to the collector group, execute a script to:
generate a second client certificate for the first endpoint;
store the second client certificate in a storage unit; and
update, via a configuration agent of the first endpoint, the first endpoint to:
replace the first client certificate with the second client certificate; and
post metrics to a second service at the remote collector based on the second client certificate.

14. The non-transitory computer-readable storage medium of claim 13, wherein instructions to generate the second client certificate for the first endpoint comprise instructions to:
generate the second client certificate for the first endpoint using a Certificate Authority (CA) certificate of the collector group.

15. The non-transitory computer-readable storage medium of claim 13, wherein instructions to update the first endpoint comprise instructions to:
cause a configuration master of the second endpoint to update the first endpoint via the configuration agent running in the first endpoint, and wherein the configuration agent is to receive a control command from the configuration master and execute the control command to update the first endpoint.

16. The non-transitory computer-readable storage medium of claim 13, wherein instructions to update the first endpoint comprise instructions to:
cause a configuration master of the second endpoint to apply, via the configuration agent running in the first endpoint, a control command to the first endpoint to:
stop an application monitoring agent and a service discovery agent running in the first endpoint;
download the stored second client certificate from the storage unit of the remote collector to the first endpoint;
replace the first client certificate with the downloaded second client certificate;
replace a fully qualified domain name (FQDN) used by the first endpoint to post the metrics to the first service with a virtual Internet Protocol (IP) address of the second service; and
start the application monitoring agent and the service discovery agent on the first endpoint to enable the application monitoring agent and the service discovery agent to post the metrics to the virtual IP address based on the second client certificate.

17. A method performed by a remote collector executing on a second endpoint, comprising:
receiving, via a first service, metrics of a first endpoint based on a first client certificate and send the metrics to a monitoring application;
detecting that the second endpoint has been removed from a collector group that shares responsibility for monitoring functions to support high availability; and
in response to detecting that the second endpoint has been removed from the collector group, executing a script to:
generate a second client certificate for the first endpoint;
store the second client certificate in a storage unit; and
update, via a configuration agent of the first endpoint, the first endpoint to:
replace the first client certificate with the second client certificate; and
post metrics to a second service at the remote collector based on the second client certificate.

18. The method of claim 17, wherein generating the second client certificate for the first endpoint comprises:
generating the second client certificate for the first endpoint using a self-signed Certificate Authority (CA) certificate of the remote collector.

19. The method of claim 17, wherein updating the first endpoint comprises:
causing a configuration master of the second endpoint to update the first endpoint via the configuration agent running in the first endpoint, wherein the configuration agent is to receive a control command from the configuration master and execute the control command to update the first endpoint.

20. The method of claim 17, wherein updating the first endpoint comprises:
causing a configuration master of the second endpoint to apply, via the configuration agent running in the first endpoint, a control command to the first endpoint to:
stop at least one agent running in the first endpoint, wherein the at least one agent is to use the first client certificate to send metrics of the endpoint to the first service;
download the stored second client certificate from the storage unit of the remote collector to the first endpoint;
replace the first client certificate with the downloaded second client certificate;
replace a virtual Internet Protocol (IP) address used by the endpoint to post the metrics to the first service with a fully qualified domain name (FQDN) of the second service; and
start the at least one agent such that the at least one agent is to post the metrics to the FQDN of the second service based on the second client certificate.
